(19) United States
(12) Patent Application Publication
(10) Pub. No.: US 2001/0042100 A1
(43) Pub. Date: Nov. 15, 2001

(54) Unified system and methodology for remote access to e-mail

(76) Inventors: David Guedalia, Beit Shemesh (IL); Lawrence Reisler, Beit Shemesh (IL); Gavriel Raanan, Beit Shemesh (IL)

Correspondence Address: ABELMAN FRAYNE & SCHWAB, Attorneys at Law, 150 East 42nd Street, New York, NY, 10017, US

(21) Appl. No.: 09/835,283

(22) Filed: Apr. 12, 2001

Related U.S. Application Data
(60) Provisional application No. 60/197,901, filed on Apr. 14, 2000.

(51) Int. Cl. G06F 15/16

(52) U.S. Cl. 709/206; 709/217

(57) ABSTRACT

An e-mail retrieval system including an IMAP e-mail server employing an IMAP protocol, a thin e-mail client and an IMAP server-thin e-mail client communication module enabling the thin e-mail client to retrieve e-mail from the IMAP server using the IMAP protocol.

### REFERENCE TO RELATED APPLICATIONS

This application claims priority from co-pending U.S. Provisional Application Serial No. 60/197,901 entitled lnternet Message Access Protocol (IMAP), filed Apr. 14, 2001.

### FIELD OF THE INVENTION

The present invention relates to accessing e-mail messages via a telephone.

### BACKGROUND OF THE INVENTION

Today, e-mail is a crucial component of the work environment and one of the most popular modes of communication between friends and families. In a relatively short space of time, e-mail has grown from a mere convenience to a mission-critical application.

E-mail messages are not always merely text based, but have become relatively complex and may contain non-text components. For example, e-mail messages can include video clips, graphics and audio messages. A user can store received e-mail for future reference and convenience.

When e-mail was first used, the e-mail services was operated by a mainframe computer and access was limited to those users who had accounts on the mainframe. Later, e-mail was stored on a local server and e-mail applications were mainly designed for LAN use. Today, most e-mail works based on a client/server system, whereby the client is responsible for creating transmitting and receiving e-mail messages and the server stores the messages.

Recently, the nature of e-mail access has changed. There is present a shift towards Internet storage of e-mail in what may be considered to be a ‘third generation’ of e-mail applications. E-mail has become remotely accessible by virtue of Internet e-mail storage. A user can now access e-mail from almost anywhere—for example, from cafes and airports—and no longer needs to use a specific home or office computer to retrieve e-mail messages.

E-mail is usually managed either by an e-mail server or an e-mail client. An e-mail server is a central computer that is accessed by remote users who are registered with the server as authorized users. An e-mail server manages the users' incoming and outgoing e-mail. An e-mail client exists on a remote computer, downloading incoming e-mail messages from the server and sending outgoing messages from the client to the server.

Retrieval of e-mail messages is made possible through the use of a suitable protocol. There are two main e-mail retrieval protocols in use today; the Post Office Protocol (POP) and the Internet Message Access Protocol (IMAP). The protocol used when retrieving e-mail messages defines the functionality available to the user.

POP is the oldest and most prolific e-mail retrieval protocol in use today. POP works in an ‘offline’ mode whereby a POP client connects to a mail server; the mail server downloads new e-mail to the user's computer and then deletes the mail from server, keeping no record of the mail once it has been downloaded. All further mail processing is carried out on the client,

One drawback of POP is the fact that it does not parse e-mail messages on the server beyond the primary header. Attempts have been made to use POP in an ‘online’ mode. These attempts have not been particularly successful inasmuch as POP does riot possess capabilities required for efficient ‘online’ functioning.

IMAP is a more complex protocol, offering flexibility and functionality that POP lacks, With IMAP, a user can access new and stored mail from anywhere. An IMAP server stores messages on a central server. The messages stored on the server can be manipulated from a desktop computer at home, a workstation at the office, and a notebook computer while traveling, without the need to transfer messages or files back and forth between these computers.

When a user downloads messages to a local computer, the server still retains a copy of the messages. IMAP can provide the user with only the header of a message, allowing the user to choose what to download and read. This saves on bandwidth, because the user does not have to wait for download of heavy attachments before being able to read the main text of the e-mail message.

IMAP gives users the option of creating new folders, such as work personal and miscellaneous files, whereas new folders cannot be created through POP. IMAP has the capability to deal with large sized messages. It can separate parts of messages that are not deemed of immediate importance to the user and leave them on the server, where they are stored until the user wishes to view them. For instance, a user travelling with a laptop may receive an e-mail message from a colleague at work with a 10-MB movie clip attached, The user can choose to read the colleague's message while leaving the 10-MB clip on server to view upon his return to the office. The ability to separate messages is one of the main advantages that IMAP has over POP.

Another advantage that IMAP has over POP is its capacity for conducting searches. IMAP uses the server for searching and can conduct searches of mailboxes, looking, for instance, for a specific title of a message or for all messages sent by a certain user.

IMAP also enables shared mailboxes. For example, a group of co-workers can access messages from the same mailbox at the same time. IMAP allows simultaneous access and changes to shared mailboxes, enabling many co-workers to work on the same project, and allowing changes made to the contents of the mailbox to be seen by all users. IMAP enables the user to manipulate remote mailboxes in the same manner as local mailboxes. In some cases, the user has the option of either saving messages to a client or saving them on the server, depending on the client and the system architecture.

With the advent of Internet storage of e-mail and increased mobility of Internet access, methods of access and storage have changed to meet the needs of the mobile user. Web-mail enables roaming access for the user, using a central server, which is accessible via the Internet from any computer, anywhere in the world, Web-based e-mail offers features that e-mail client applications cannot provide and solves problems of preserving the meta-content of e-mail, such as folders and address books. Using Web-mail, the user has the convenience of downloading mail from different machines at different times while still keeping all e-mail messages together in one place. The mobile user can keep in touch with the office and clients while on the road using a web-based e-mail account.

### SUMMARY OF THE INVENTION

There is provided in accordance with a preferred embodiment of the present invention, an e-mail retrieval system including an IMAP e-mail server employing an IMAP protocol, a thin e-mail client and an IMAP server-thin e-mail client communication module enabling the thin e-mail client to retrieve e-mail from the IMAP server using the IMAP protocol.

There is also provided in accordance with a preferred embodiment of the present invention an e-mail retrieval method including employing an IMAP protocol in an IMAP e-mail server and enabling a thin e-mail client to retrieve e-mail from the IMAP server using the IMAP protocol.

Preferably, the IMAP server-thin e-mail client communication module includes:

a communications conversion module which converts communications from the IMAP server into a communication protocol;

a forming module receiving data in the communication protocol and formatting the data into formatted data for the thin client; and

a communication server receiving the formatted data from the formatting module and transmitting the formatting data to the thin client.

The thin client typically includes at least one of a WAP client, a WML client and an HTML client.

Additionally in accordance with a preferred embodiment of the present invention there is provided an audio browser which is operative to communicate between the thin e-mail client and the IMAP server-thin e-mail client communication module.

In accordance with a preferred embodiment of the present invention, the thin e-mail client comprises a telephone.

There is additionally provided in accordance with a preferred embodiment of the present invention an e-mail retrieval system, including a POP e-mail server employing a POP protocol, a thin e-mail client and a POP server-thin e-mail client communication module enabling the thin e-mail client to retrieve e-mail from the POP server using an IMAP protocol.

There is also provided in accordance with a preferred embodiment of the present invention an e-mail retrieval method including employing a POP protocol in a a POP e-mail server and enabling the thin e-mail client to retrieve e-mail fom the POP server using an IMAP protocol.

In this embodiment, the POP server-thin e-mail client communication module preferably includes:

a POP to IMAP conversion module which converts communications from the POP server to IMAP;

a communications conversion module which converts communications from the POP to IMAP conversion module into a communication protocol;

a formatting module receiving data in the communication protocol and formatting the data into formatted data for the thin client; and

a communication server receiving the formatted data from the formatting module and transmitting the formatting data to the thin client.

Preferably, the POP to IMAP conversion module provides functionalities not provided by the POP protocol.

In accordance with a preferred embodiment of the present invention, the system also includes an audio browser which is operative to communicate between the thin e-mail client and the POP server-thin e-mail client communication module.

There is additionally provided in accordance with a preferred embodiment of the present invention an e-mail retrieval system, including:

an HTTP server employing an HTTP protocol;

a thin e-mail client; and

an HTTP server-thin e-mail client communication module enabling the thin e-mail client to retrieve e-mail from the HTTP server using an IMAP protocol. Corresponding methodology is also provided.

In this embodiment, the HTTP server-thin e-mail client communication module preferably includes:

an HTTP to IMAP conversion module which converts communications from the HTTP server to IMAP;

a communication conversion module which converts communications from the HTTP to IMAP conversion module into a communication protocol;

a formatting module receiving data in the communication protocol and formatting the data into formatted data for the thin client; and

a communication server receiving the formatted data from the formatting module and transmitting the formatting data to the thin client.

Preferably the HTTP to IMAP conversion module provides functionalities not provided by the HTTP protocol.

Additionally in accordance with a preferred embodiment of the present invention, there is also provided an audio browser which is operative to communicate between the thin e-mail client and the HTTP server-thin e-mail client communication module.

### BRIEF DESCRIPTION OF THE DRAWINGS

The present invention will be more fully understood and appreciated from the following detailed description, taken in conjunction with the drawings in which;

FIG. 1 is a simplified block diagram of a system and methodology for accessing e-mail messages in accordance with a preferred embodiment of the present invention,

FIG. 2 is a simplified flow chart, illustrating operation of the system and methodology of FIG. 1;

FIG. 3 is a simplified block diagram, illustrating part of the system and methodology of FIG. 1 configured for accessing e-mail messages via a cellular telephone; and

FIG. 4 is a simplified flow chart illustrating operation of the system and methodology of FIG. 3.

### DETAILED DESCRIPTION OF A PREFERRED EMBODIMENT

The introduction which follows provides a basis for understanding the detailed description of the drawings.

E-mail retrieval may be effected through the use of an e-mail client, which may be organized into two categories, thick and thin. Thick clients typically require an application, a computer, and an operating system and are capable of rendering information retrieved from an e-mail server via the IMAP protocol and providing complex functionality based directly on that information, Thin clients typically have greater mobility and portability than thick clients. However, thin clients may have less software and less processing power. Thus, thin clients may require parsing and formatting of information retrieved from an e-mail server before being able to render the information. Accordingly thin clients, as the term is used throughout, are unable to employ the IMAP protocol.

HTML, HDML, WML and audio browsers are four examples of thin clients that enable e-mail retrieval. A user who wishes to access e-mail information through a conventional personal computer may employ an HTML browser. HTML browsers enable access to e-mail information that may contain either text or audio content.

Alternatively, the user may employ an HDML or WML browsers which may be embedded in a mobile telephone. HDML and WML embedded browsers typically only support text content.

Similarly, the user may employ an audio browser. A telephone may thus be employed to access e-mail information. The e-mail information is converted from text to speech and relayed through the audio browser over the telephone.

The system and methodology described in the present invention provides the user with the choice of various modes of access to e-mail and web-based information including, for example, HTML, HDML, WML and audio.

The present invention also provides a unified system and methodology of accessing e-mail through a thin client. The present invention additionally enables access to e-mail information, utilizing mail formatting to support multiple types of browsers and IMAP conversion modules to retrieve e-mail information from different types of e-mail servers.

Typically e-mail information is accessed via an IMAP, HTTP or a POP server using respective IMAP, HTTP and POP protocols. The present invention provides conversion modules that access the e-mail information stored on the various servers, converting the different protocols to IMAP as necessary,

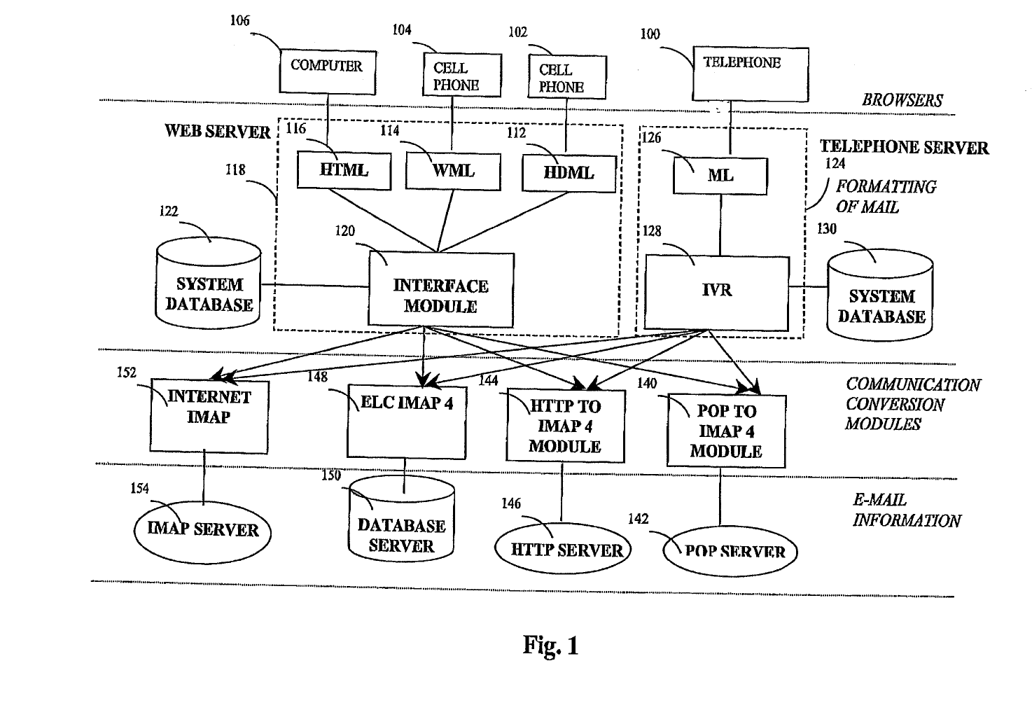

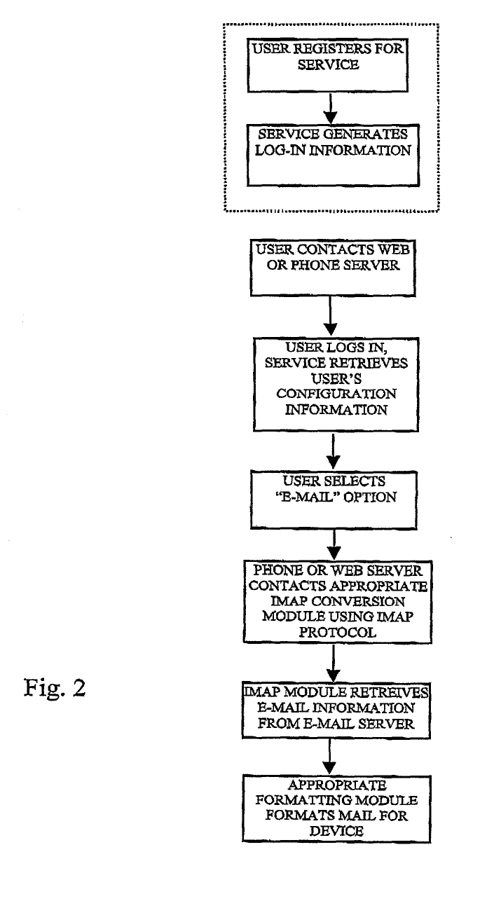

Reference is now made to FIG. 1 which is a simplified functional block diagram illustrating the structure of a system and methodology for retrieval of e-mail constructed and operative in accordance with a preferred embodiment of the present invention and to FIG. 2, which is a simplified flowchart illustrating the operation of the system and methodology of FIG. 1.

The system and methodology of FIGS. 1 and 2 are adapted to employ browsers which may be accessible from a number of different types of thin clients, including, for example, a telephone 100, an HDML equipped cellular telephone 102, a WML equipped cellular telephone 104 and a personal computer 106. HDML, WML and HTML formatting modules, respectively indicated by reference numerals 112; 114 and 116 preferably reside in a web server 118 which preferably also includes an interface module 120. Interface module 120 preferably communicates with a system database 122.

A telephone server 124 includes a formatting module 126, which employs voice XML or ELML interpreters and which interacts with an imperative voice response unit (IVR) 128, which in turn preferably communicates with a system database 130.

The present invention provides a plurality of communication conversion modules, one or more of which may be employed in any system configuration, The communication conversion modules preferably include a POP to IMAP conversion module 140 which preferably converts POP to IMAP4. Module 140 preferably communicates with a POP server 142. When the system and functionality of the present invention employ module 140 and POP server 142, there is provided an e-mail retrieval system, comprising:

a POP e-mail server employing a POP protocol, here represented by POP server 142;

a thin e-mail client, here represented by any of elements 100, 102, 104 and 106; and

a POP server-thin e-mail client communication module enabling the thin e-mail client to retrieve e-mail from the POP server using an IMAP protocol, here represented by module 140 together with web server 118 or telephone server 124.

In such a case, the POP server-thin e-mail client communication module comprises:

a POP to IMAP conversion module, here represented by module 140, which converts communications from the POP server 142 to an IMAP protocol;

a communications' conversion module, here represented by modules 120 and 128, which converts communications from the POP to IMAP conversion module 140 into a communication protocol;

a formatting module, here represented by modules 112, 114, 116 and 126, receiving data in the communication protocol and formatting the data into formatted data for the thin client; and

a communication server, here represented within 118 and 124, receiving the formatted data from the formatting module and transmitting the formatting data to the thin client.

The communication conversion modules preferably also include an HTTP to IMAP conversion module 144 which preferably converts HTTP to IMAP4. Module 144 preferably communicates with an HTTP server 146. When the system and functionality of the present invention employ module 144 and HTTP server 146, there is provided an e-mail retrieval system, comprising:

an HTTP e-mail server employing an HTTP protocol, here represented by HTTP server 146;

a thin e-mail client, here represented by any of elements 100, 102, 104 and 106; and

an HTTP server-thin e-mail client communication module enabling the thin e-mail client to retrieve e-mail from the HTTP server using an IMAP protocol, here represented by module 144 together with web server 118 or telephone server 124.

In such a case, the HTTP server-thin e-mail client communication module comprises:

an HTTP to IMAP conversion module, here represented by module 144, which converts communications from the server 146 to an IMAP protocol;

a communications conversion module, here represented by modules 120 and 128, which converts communications from the HTTP to IMAP conversion module 144 into a communication protocol;

a formatting module, here represented by modules 112, 114, 116 and 126, receiving data in the communication protocol and formatting the data into formatted data for the thin client; and

a communication server, here represented within 118 and 124, receiving the formatted data from the formatting module and transmitting the formatting data to the thin client.

The communication conversion modules preferably also include IMAP interfaces 148 and 152 which interface with database server 150 and IMAP server 154 respectively. When the system and functionality of the present invention employ interfaces 148 and 152, database server 150 and IMAP server 154, there is provided an e-mail retrieval system, comprising:

an e-mail storage device, here represented by database server 150 and IMAP server 154;

a thin e-mail client, here represented by any of elements 100, 102, 104 and 106; and

an storage device-thin e-mail client communication module enabling the thin e-mail client to retrieve e-mail from the storage device using an IMAP protocol, here represented by interfaces 148 and 152 together with web server 118 or telephone server 124.

In such a case, the storage device-thin e-mail client communication module comprises:

IMAP interfaces, here represented by modules 148 and 152, which convert communications from the storage devices 150 and 154 to an IMAP protocol;

a communications conversion module, here represented by modules 120 and 128, which converts communications from the IMAP interfaces 148 and 152 into a communication protocol;

a formatting module, here represented by modules 112, 114, 116 and 126, receiving data in the communication protocol and formatting the data into formatted data for the thin client; and

a communication server, here represented within 118 and 124, receiving the formatted data from the formatting module and transmitting the formaig data to the thin client.

As seen in FIG. 2, in a set-up phase, prior to establishing contact with the web or phone server, a user registers and login information is generated,

Following the set-up phase, the user contacts either a web server 118 or a telephone server 124. The user logs in and the service retrieves the user's configuration information. Next, the user receives a prompt to make a selection from the menu and the user selects “e-mail”. The appropriate server, either the web server 118 or the telephone server 124, contacts the appropriate IMAP conversion module or IMAP interface, for example any of POP to IMAP4 module 140, ITTP to IMAP4 module 144 and IMAP interfaces 148 and 152 and communicates via the IMAP protocol. The IMAP conversion module retrieves the e-mail information from the appropriate e-mail server, which may be any of POP server 142, HTTP server 146 and storage devices 150 and 154, using their respective protocols,

In one embodiment of the present invention the user employs a web browser located in computer 106 to retrieve e-mail information. The user opens up the web browser and may direct the browser using a standard direction method, such as typing in the URL or accessing the URL through a previously defined bookmark. Upon connection, the user may be prompted to enter login information to gain access to the user's personal account

In an alternative embodiment of the present invention) the user may employ an internet enabled cell phone 102 or 104, that contains an embedded HDML or WML browser respectively, to retrieve the e-mail information. The user may open up the HDML or WML, browser and may direct it to the Web Server 118 of the present invention using a standard direction method such as typing in the URL or accessing the URL through a previously defined bookmark, Upon connection, the user may be prompted to enter login information to gain access to the user's personal account.

Similarly, in further alternative embodiment of the present invention, a user employs an audio browser, typically using telephone 100, to retrieve e-mail information, The user may place a call to a telephone server 124, which may include an ML menu system 126 and an IVR 128. Upon connection, the user may be prompted to enter login information to gain access to the user's personal account.

Common to the methods of access that employ web server 118, is interface module 120, Interface module 120 provides a uniform interface for web access.

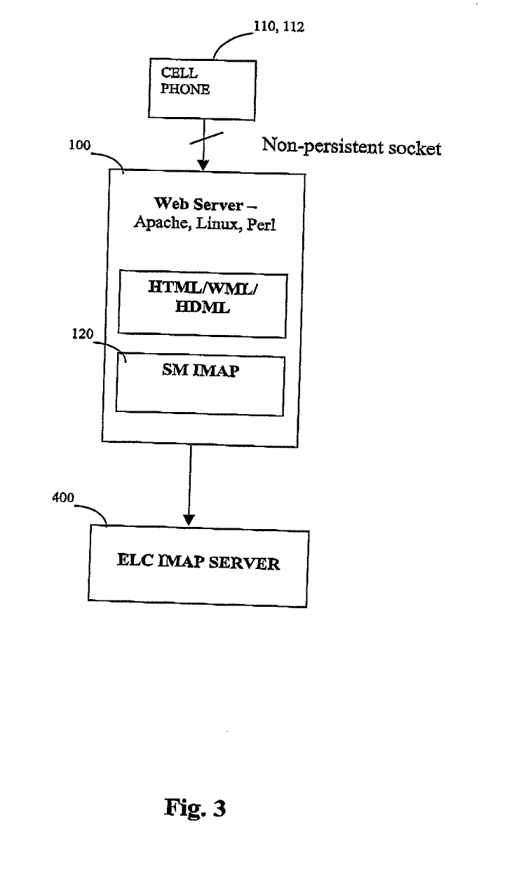

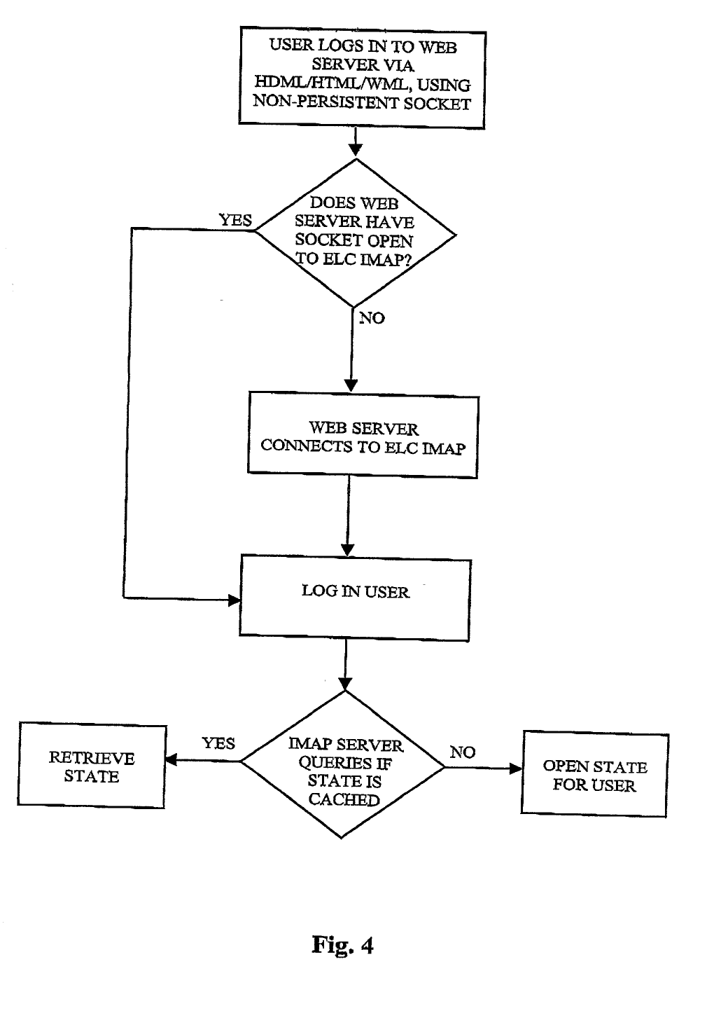

Reference is now made to FIG. 3 which is a simplified functional block diagram illustrating accessing an account via an internet enabled cell phone, such as WAP enabled telephone 102 and 104 (FIG. 1), and to FIG. 4, which is a simplified flowchart illustrating the process of accessing an account via a telephone in accordance with a preferred embodiment of the present invention.

A user typically opens up a browser on an internet enabled cell phone 102 or 104, such as a WAP enabled telephone, and may direct the browser to the Web Server 118 of the present invention, using a standard direction method such as typing in the URL or accessing the URL tough a previously defined bookmark. The user may then be presented with a login screen, where the user's e-mail address may be entered. When the user logs in, a persistent socket is opened between the Web Server 118 and an ELC IMAP Server 400, which is a preferred embodiment of interface 148 (FIG. 1). A persistent socket is used because the process of opening and closing a socket is relatively slow. The Web Server 118 communicates via the persistent socket and verifies details supplied by the user with the ELC IMAP Server 400.

ELC IMAP Server 400 queries whether the use's state is still cached. If the state is cached, the ELC IMAP server 400 retrieves it. If the state is not cached, the ELC IMAP Server 400 opens a new state for the user.

It will be appreciated by persons skilled in the art that the present invention is not limited by what has been particularly shown and described hereinabove. Rather the present invention includes combinations and sub-combinations of the various features described hereinabove as well as modifications and extensions thereof, which would occur to a person skilled in the art and which do not fall within the prior art.

1. An e-mail retrieval system comprising:
an IMAP e-mail server employing an IMAP protocol;
a thin e-mail client; and
an UP server-thin e-mail client communication module enabling said thin e-mail client to retrieve e-mail from said IMAP server using said IMAP protocol.

2. An e-mail retrieval system according to claim 1 and wherein said IMAP server-thin e-mail client communication module comprises:
a communications conversion module which converts communications from said IMAP server into a communication protocol;
a formatting module receiving data in said communication protocol and formatting said data into formatted data for said thin client; and
a communication server receiving said formatted data from said formatting module and transmitting said formatting data to said thin client.

3. A system according to claim 1 and wherein said thin client comprises at least one of a WAP client, a WML client and an HTML client.

4. A system according to claim 1 and also comprising an audio browser which is operative to communicate between said thin e-mail client and said IMAP server-thin e-mail client communication module.

5. A system according to claim 4 and wherein said thin e-mail client comprises a telephone.

6. An e-mail retrieval method, comprising:
employing an IMAP protocol in an IMAP e-mail server; and
enabling a thin e-mail client to retrieve e-mail from said IMAP server using said IMAP protocol.

7. An e-mail retrieval method according to claim 7 and wherein said enabling comprises:
converting commutations from said IMAP server into a communication protocol;
receiving data and formatting said data into formatted data for said thin client; and
receiving said formatted data and transmitting said formatting data to said thin client.

8. A method according to claim 6 and wherein said thin client comprises at least one of a WAP client, a WML client and an HTML client.

9. A method according to claim 6 and also comprising employing an audio browser to communicate between said thin e-mail client and said IMAP server.

10. A method according to claim 9 and wherein said thin e-mail client comprises a telephone.

11. An e-mail retrieval system, comprising:
a POP e-mail server employing a POP protocol;
a thin e-mail client; and
a POP server-thin e-mail client communication module enabling said thin e-mail client to retrieve e-mail from said POP server using an IMAP protocol.

12. An e-mail retrieval system according to claim 11 and wherein said POP server-thin e-mail client communication module comprises:
a POP to IMAP conversion module which converts communications from said POP server to IMAP;
a communications conversion module which converts communications from said POP to IMAP conversion module into a communication protocol;
a formatting module receiving data in said communication protocol and formatting said data into formatted data for said thin client; and
a communication server receiving said formatted data from said formatting module and transmitting said formatting data to said thin client.

13. A system according to claim 11 and wherein said thin client comprises at least one of a WAP client, a WML client and an HTML client

14. A system according to claim 12 and wherein said POP to IMAP conversion module provides functionalities not provided by said POP protocol.

15. A system according to claim 11 and also comprising an audio browser which is operative to communicate between said thin e-mail client and said POP server-thin e-mail client communication module.

16. A system according to claim 15 and wherein said thin e-mail client comprises a telephone.

17. An e-mail retrieval method, comprising:
employing a POP protocol in a a POP e-mail server; and
enabling said thin e-mail client to retrieve e-mail from said POP server using an IMAP protocol.

18. An e-mail retrieval method according to claim 17 and wherein said enabling comprises:
converting communications from said POP server to IMAP;
converting communications from IMAP into a communication protocol;
receiving data and formatting said data into formatted data for said thin client; and
receiving said formatted data and transmitting said formatting data to said thin client.

19. A method according to claim 17 and wherein said enabling provides functionalities not provided by said POP protocol.

20. A method according to claim 17 and also comprising employing an audio browser to communicate between said thin e-mail client and said POP server.

21. An e-mail retrieval system, comprising:
an HTTP server employing an HTTP protocol;
a thin e-mail client; and
an HTTP server-thin e-mail client communication module enabling said thin e-mail client to retrieve e-mail from said HTTP server using an IMAP protocol.

22. An e-mail retrieval system according to claim 21 and therein said HTTP server-thin e-mail client communication module comprises:
an HTTP to IMAP conversion module which converts communications from said HTIP server to IMAP;
a communications conversion module which converts communications from said HTTP to IMAP conversion module into a communication protocol;
a formatting module receiving data in said communication protocol and formatting said data into formatted data for said thin client; and
a communication server receiving said formatted data from said formatting module and transmitting said formatting data to said thin client.

23. A system according to claim 21 and wherein said thin client comprises at least one of a WAP client a WML client and an HTML client

24. A system according to claim 22 and wherein said HTTP to IMAP conversion module provides functionalities not provided by said HTTP protocol.

25. A system according to claim 21 and also comprising an audio browser which is operative to communicate between said thin e-mail client and said HTTP server-thin e-mail client communication module.

26. A system according to clam 25 and wherein said thin e-mail client comprises a telephone.
